(19) United States
(12) Patent Application Publication
(10) Pub. No.: US 2025/0203357 A1
(43) Pub. Date: Jun. 19, 2025

(54) COMMUNICATION METHOD AND DEVICE IN WIRELESS LOCAL AREA NETWORK

(71) Applicant: HUAWEI TECHNOLOGIES CO., LTD., Shenzhen (CN)

(72) Inventors: Ming GAN, Shenzhen (CN); Dandan LIANG, Shenzhen (CN)

(21) Appl. No.: 18/999,795

(22) Filed: Dec. 23, 2024

Related U.S. Application Data
(63) Continuation of application No. 17/534,763, filed on Nov. 24, 2021.
Application No. 17/534,763 is a continuation of application No. PCT/CN2020/090937, filed on May 19, 2020.

(30) Foreign Application Priority Data
May 24, 2019 (CN) 201910442169.5

(51) Int. Cl. H04W 12/0431; H04W 36/00; H04W 36/14

(52) U.S. Cl. CPC H04W 12/0431; H04W 36/0038; H04W 36/14

(57) ABSTRACT

This application provides a communication method and device in a wireless local area network. The communication method includes: A receive end receives indication information from a transmit end, where a buffer of the receive end stores a log-likelihood ratio (LLR) corresponding to coded bits in an aggregated media access control protocol data unit (A-MPDU) subframe including a target media access control protocol data unit (MPDU). The receive end discards the LLR corresponding to the coded bits in the A-MPDU subframe including the target MPDU according to the indication information. According to the technical solutions provided in this application, the LLR corresponding to the coded bits in the buffer of the receive end can be discarded in time, thereby improving throughput of a system and reducing memory requirements.

### CROSS-REFERENCE TO RELATED APPLICATIONS

This application is a continuation of U.S. patent application Ser. No. 17/534,763, filed on Nov. 24, 2021, which is a continuation of International Application No. PCT/CN2020/090937, filed on May 19, 2020, which claims priority to Chinese Patent Application No. 201910442169.5, filed on May 24, 2019. All of the afore-mentioned patent applications are hereby incorporated by reference in their entireties.

### TECHNICAL FIELD

This application relates to the field of wireless communication, and in particular, to a communication method and device in a wireless local area network.

### BACKGROUND

In a communication system, signal transmission fails due to time variant characteristics and multi-path fading of wireless channels. Error control is usually performed by using methods such as a forward error correction (Forward Error Correction, FEC) coding technology and an automatic repeat request (Automatic Repeat-reQuest, ARQ). For example, in a wireless local area network (Wireless Local Area Network, WLAN), when an access point (Access Point, AP) sends data to a station (Station, STA), if the STA successfully receives the data, the STA feeds back an acknowledgment (Acknowledge, ACK) frame to the AP. If the STA fails to receive the data, the STA does not feed back any frame. If the AP does not receive any feedback, the AP retransmits the sent data to achieve error control.

Based on the ARQ, a hybrid automatic repeat request (Hybrid Automatic Repeat-reQuest, HARQ) is further introduced in standards such as long term evolution (Long Term Evolution, LTE). A receive end prestores data received for the first time, and when receiving retransmitted data, combines the data received for the first time and the received retransmitted data, to increase a decoding success rate. Because the HARQ may further increase a success rate of receiving the retransmitted data, a HARQ mechanism is usually used in deep fading areas or edge areas during wireless communication. The HARQ mechanism may enable a transmit end to use a more advanced modulation and coding scheme (Modulation and Coding Scheme, MCS), thereby improving transmission efficiency.

The HARQ technology requires the receive end to store data that is not correctly transmitted, and this increases a memory requirement. If data stored in a memory is not processed in time, a throughput rate of an entire system is affected. Therefore, how to effectively manage a memory is a problem that needs to be resolved urgently.

### SUMMARY

This application provides a communication method and device in a wireless local area network.

According to a first aspect, a communication method in a wireless local area network is provided. The communication method includes: A receive end receives indication information from a transmit end, and the receive end discards an LLR corresponding to coded bits in an A-MPDU subframe including a target MPDU according to the indication information. A buffer of the receive end stores the log-likelihood ratio (LLR) corresponding to the coded bits in the aggregated media access control protocol data unit (A-MPDU) subframe including the target media access control protocol data unit (MPDU).

According to the method used in this embodiment of this application, an LLR corresponding to coding bits in the buffer can be discarded or deleted in time, to improve throughput of a system and reduce memory requirements.

With reference to the first aspect, in some implementations of the first aspect, the indication information is BAR information in a block acknowledgment request (BAR) frame. The BAR frame further includes BAR type information. The BAR type information is used to indicate that the BAR frame corresponds to a hybrid automatic repeat request (HARQ).

According to this embodiment of this application, a BAR type HARQ indication method is used to indicate that a BAR type is discarding the LLR corresponding to the coding bits. The receive end may discard, in time, an LLR of coding bits in an MPDU that is unnecessary, times out, or fails. Therefore, the receive end using a HARQ technology has lower requirements for a memory storing the LLR. In addition, according to this method, the receive end can efficiently discard the LLR in the buffer without a need to adjust a receive window.

With reference to the first aspect, in some implementations of the first aspect, the BAR information includes an end sequence number. The target MPDU is an MPDU whose sequence number in the MPDU corresponding to the LLR stored in the buffer is less than the end sequence number.

With reference to the first aspect, in some implementations of the first aspect, the BAR frame further includes a traffic type bitmap. The traffic type bitmap is used to indicate traffic corresponding to the BAR frame.

A TID bitmap in a BAR frame is provided in this embodiment of this application. An end sequence number is used to discard an LLR corresponding to coding bits in a specific MPDU whose sequence number is less than the end sequence number. The receive end may discard, in time, the LLR of the coding bits in the MPDU that is unnecessary, times out, or fails. Therefore, the receive end using the HARQ technology has lower requirements for the memory storing the LLR.

With reference to the first aspect, in some implementations of the first aspect, the indication information is a first sequence number of an MPDU carried in a received MAC frame. If the first sequence number is greater than an end sequence number of the receive window of the receive end and is less than a start sequence number+2¹¹, the receive end adjusts the receive window, so that the first sequence number is located in the receive window. The target MPDU is an MPDU whose sequence number is less than a start sequence number of an adjusted receive window.

According to the communication method used in this embodiment of this application, the receive end may discard, in time, the LLR of the coding bits in the MPDU that is unnecessary, times out, or fails. Therefore, the receive end using the HARQ technology has lower requirements for the memory storing the LLR. In addition, the transmit end device does not need to additionally send another indication indicating the receive end to discard the LLR in the buffer. Therefore, the transmit end can improves its efficiency and the LLR corresponding to the unnecessary coding bits is discarded in time.

With reference to the first aspect, in some implementations of the first aspect, an adjusted end sequence number is the first sequence number, and an adjusted start sequence number is equal to the end sequence number−a window length+1.

With reference to the first aspect, in some implementations of the first aspect, the method further includes: If the first sequence number is less than the start sequence number of the receive window of the receive end and is greater than or equal to the start sequence number+2¹¹, the receive end does not buffer an LLR corresponding to coding bits in a received A-MPDU subframe including an MPDU.

With reference to the first aspect, in some implementations of the first aspect, the indication information is a second sequence number indicated by a start sequence number subfield in the BAR frame. If a second sequence number is greater than the start sequence number of the receive window of the receive end and is less than the start sequence number+2¹¹, the receive end adjusts the receive window, so that the start sequence number is equal to the second sequence number. The receive end determines an MPDU whose sequence number is less than a start sequence number of an adjusted receive window as the target MPDU.

According to the communication method used in this embodiment of this application, the receive end may discard, in time, the LLR of the coding bits in the MPDU that is unnecessary, times out, or fails. Therefore, the receive end using the HARQ technology has lower requirements for the memory storing the LLR. In addition, the transmit end device may set the second sequence number in the BAR frame to accurately control the receive end to discard the LLR of the coding bits.

With reference to the first aspect, in some implementations of the first aspect, the indication information is retransmission indication information in a preamble of a physical layer protocol data unit (PPDU). If the retransmission indication information is a first value, the PPDU does not carry a retransmitted MPDU or carries a retransmitted MPDU that does not require a HARQ operation, and the target MPDU is all of the MPDUs corresponding to the LLR stored in the buffer. If the retransmission indication information is a second value, the PPDU carries a retransmitted MPDU, and combining and decoding or joint decoding are or is performed on the retransmitted MPDU and the LLR corresponding to the coding bits.

According to the communication method used in this embodiment of this application, the receive end may discard, in time, the LLR of the coding bits in the MPDU that is unnecessary, times out, or fails. Therefore, the receive end using the HARQ technology has lower requirements for the memory storing the LLR. In addition, the transmit end device does not need to additionally send another indication indicating the receive end to discard the LLR in the buffer. Therefore, the transmit end can improve its efficiency and the LLR corresponding to the unnecessary coding bits is discarded in time.

According to a second aspect, a communication method in a wireless local area network is provided. The communication method includes: A transmit end sends indication information to a receive end, where the indication information is used to indicate the receive end to discard an LLR corresponding to coded bits in an A-MPDU subframe including a target MPDU according to the indication information. With reference to the second aspect, in some implementations of the second aspect, the indication information is BAR information in a block acknowledgment request (BAR) frame. The BAR frame further includes BAR type information. The BAR type information is used to indicate that the BAR frame corresponds to a hybrid automatic repeat request (HARQ).

With reference to the second aspect, in some implementations of the second aspect, the BAR information includes an end sequence number. The target MPDU is an MPDU whose sequence number in an MPDU corresponding to an LLR stored in a buffer is less than the end sequence number.

With reference to the second aspect, in some implementations of the second aspect, the BAR frame further includes a traffic type bitmap. The traffic type bitmap is used to indicate traffic corresponding to the BAR frame.

With reference to the second aspect, in some implementations of the second aspect, the indication information is retransmission indication information in a preamble of a physical layer protocol data unit (PPDU). If the retransmission indication information is a first value, the PPDU does not carry a retransmitted MPDU or carries a retransmitted MPDU that does not require a HARQ operation. The target MPDU is all of the MPDUs corresponding to the LLR stored in the buffer. If the retransmission indication information is a second value, the PPDU carries a retransmitted MPDU, and combining and decoding or joint decoding are or is performed on the retransmitted MPDU and the LLR corresponding to the coding bits.

According to a third aspect, a communication apparatus is provided. The communication apparatus includes: a receiving module configured to receive indication information, and a processing module configured to discard an LLR corresponding to coded bits in an A-MPDU subframe including a target MPDU according to the indication information. Optionally, the communication apparatus further includes a storage module, where the storage module includes a buffer, and the buffer is configured to store the log-likelihood ratio (LLR) corresponding to the coded bits in the aggregated media access control protocol data unit (A-MPDU) subframe including the target media access control protocol data unit (MPDU).

With reference to the third aspect, in some implementations of the third aspect, the indication information is BAR information in a block acknowledgment request (BAR) frame. The BAR frame further includes BAR type information. The BAR type information is used to indicate that the BAR frame corresponds to a hybrid automatic repeat request (HARQ).

With reference to the third aspect, in some implementations of the third aspect, the BAR information includes an end sequence number. The target MPDU is an MPDU whose sequence number in an MPDU corresponding to an LLR stored in the buffer is less than the end sequence number.

With reference to the third aspect, in some implementations of the third aspect, the BAR frame further includes a traffic type bitmap. The traffic type bitmap is used to indicate traffic corresponding to the BAR frame.

With reference to the third aspect, in some implementations of the third aspect, the indication information is a first sequence number of an MPDU carried in a received MAC frame. If the first sequence number is greater than an end sequence number of a receive window of a receive end and is less than a start sequence number+2¹¹, the processing module is further configured to adjust the receive window, so that the first sequence number is located in the receive window. The target MPDU is an MPDU whose sequence number is less than a start sequence number of an adjusted receive window.

With reference to the third aspect, in some implementations of the third aspect, an adjusted end sequence number is the first sequence number, and an adjusted start sequence number is equal to the end sequence number−a window length+1.

With reference to the third aspect, in some implementations of the third aspect, if the first sequence number is less than the start sequence number of the receive window of the receive end and is greater than or equal to the start sequence number+2¹¹, the communication apparatus does not buffer an LLR corresponding to coding bits in a received A-MPDU subframe including an MPDU.

With reference to the third aspect, in some implementations of the third aspect, the indication information is a second sequence number indicated by a start sequence number subfield in the BAR frame. If a second sequence number is greater than the start sequence number of the receive window of the receive end and is less than the start sequence number+2¹¹, the processing module is further configured to adjust the receive window, so that the start sequence number is equal to the second sequence number. The target MPDU is an MPDU whose sequence number is less than a start sequence number of an adjusted receive window.

With reference to the third aspect, in some implementations of the third aspect, the indication information is retransmission indication information in a preamble of a physical layer protocol data unit (PPDU). If the retransmission indication information is a first value, the PPDU does not carry a retransmitted MPDU or carries a retransmitted MPDU that does not require a HARQ operation, and the target MPDU is all of the MPDUs corresponding to the LLR stored in the buffer. If the retransmission indication information is a second value, the PPDU carries a retransmitted MPDU, and combining and decoding or joint decoding are or is performed on the retransmitted MPDU and the LLR corresponding to the coding bits.

According to a fourth aspect, a communication apparatus is provided. The communication apparatus includes: a generation module configured to generate indication information, and a sending module configured to send the indication information to a receive end. The indication information is used to indicate the receive end to discard an LLR corresponding to coded bits in an A-MPDU subframe including a target MPDU according to the indication information.

With reference to the fourth aspect, in some implementations of the fourth aspect, the indication information is BAR information in a block acknowledgment request (BAR) frame. The BAR frame further includes BAR type information. The BAR type information is used to indicate that the BAR frame corresponds to a hybrid automatic repeat request (HARQ).

With reference to the fourth aspect, in some implementations of the fourth aspect, the BAR information includes an end sequence number. The target MPDU is an MPDU whose sequence number in an MPDU corresponding to an LLR stored in a buffer is less than the end sequence number.

With reference to the fourth aspect, in some implementations of the fourth aspect, the BAR frame further includes a traffic type bitmap. The traffic type bitmap is used to indicate traffic corresponding to the BAR frame.

With reference to the fourth aspect, in some implementations of the fourth aspect, the indication information is retransmission indication information in a preamble of a physical layer protocol data unit (PPDU). If the retransmission indication information is a first value, the PPDU does not carry a retransmitted MPDU or carries a retransmitted MPDU that does not require a HARQ operation, and the target MPDU is all of the MPDUs corresponding to the LLR stored in the buffer. If the retransmission indication information is a second value, the PPDU carries a retransmitted MPDU, and combining and decoding or joint decoding are or is performed on the retransmitted MPDU and the LLR corresponding to the coding bits.

According to a fifth aspect, a network system is provided. The network system includes at least one communication apparatus according to the third aspect and at least one communication apparatus according to the fourth aspect.

According to a sixth aspect, a computer storage medium is provided. The computer-readable storage medium stores instructions, and when the instructions are run on a computer, the computer is enabled to perform the method according to any one of the foregoing aspects.

According to a seventh aspect, a computer program product including instructions is provided. When the computer program product runs on a computer, the computer is enabled to perform the method according to any one of the foregoing aspects.

According to an eighth aspect, an apparatus is provided. The apparatus includes a communication interface, a processor, and optionally a memory. The communication interface is configured to receive indication information. The memory is configured to store a log-likelihood ratio (LLR) corresponding to coded bits in an aggregated media access control protocol data unit (A-MPDU) subframe including a target media access control protocol data unit (MPDU). The processor is configured to invoke the memory to discard the LLR that is stored in the memory and that corresponds to the coded bits in the A-MPDU subframe including the target MPDU according to the indication information. Optionally, the memory may be an internal memory inside the processor, or may be an external memory coupled to the processor.

According to a ninth aspect, a chip may be an internal chip of a receive end or a transmit end. The chip includes: a processor and a communication interface. The communication interface is connected to a processing circuit through an internal connection path. The communication interface is configured to receive indication information. The processing circuit is configured to discard an LLR corresponding to coded bits in an A-MPDU subframe including a target MPDU according to the indication information.

According to a tenth aspect, a processor is included. The processor is connected to a memory through an internal connection path. The processor is configured to execute code in the memory. When the code is executed, the processor is configured to perform the method in any one of the foregoing aspects.

According to an eleventh aspect, an apparatus is provided. The apparatus is configured to implement the method in any one of the foregoing aspects.

### BRIEF DESCRIPTION OF DRAWINGS

FIG. 1 is a schematic diagram depicting an architecture of a wireless site and a wireless local area network applicable to an embodiment of this application;

FIG. 2 is a schematic diagram depicting a structure of a MAC frame according to an embodiment of this application;

FIG. 3 is a schematic interaction diagram of a communication method according to an embodiment of this application;

FIG. 4 is a schematic diagram depicting a structure of a BAR frame according to an embodiment of this application;

FIG. 5 is a schematic diagram of BAR information in a BAR frame according to an embodiment of this application;

FIG. 6 is a schematic diagram depicting a moving process of a receive window according to an embodiment of this application;

FIG. 7 is a schematic diagram depicting a structure of a communication apparatus according to an embodiment of this application;

FIG. 8 is a schematic diagram depicting a structure of a communication apparatus according to an embodiment of this application; and

FIG. 9 is a schematic diagram of an electronic device according to an embodiment of this application.

### DETAILED DESCRIPTION OF EMBODIMENTS

The following describes the technical solutions in this application with reference to the accompanying drawings.

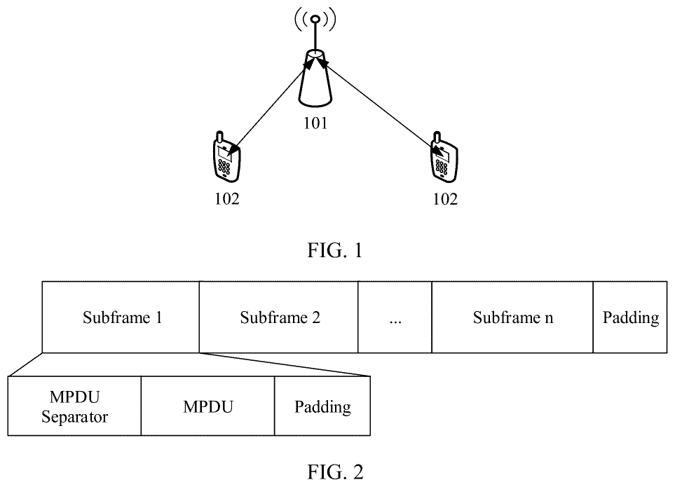

FIG. 1 is a schematic diagram depicting an architecture of a wireless local area network 100 applicable to an embodiment of this application.

As shown in FIG. 1, the wireless communication system 100 may include an access point 101 and at least one station 102. FIG. 1 is merely a schematic diagram. The communication system may further include other network devices, for example, a wireless relay device and a wireless backhaul device, which are not shown in FIG. 1. Quantities and specific types of access points and stations included in a mobile communication system are not limited in an embodiment of this application.

It should be understood that both the access point 101 and the station 102 in this embodiment may support 802.11 standards.

The station 102 in this embodiment of this application may be user equipment, an access terminal, a subscriber unit, a subscriber station, a mobile station, a remote station, a remote terminal, a mobile device, a user terminal, a terminal, a wireless communication device, a user agent, or a user apparatus. The station may be a cellular phone, a cordless phone, a session initiation protocol (Session Initiation Protocol, SIP) phone, a wireless local loop (Wireless Local Loop, WLL) station, a personal digital assistant (Personal Digital Assistant, PDA), a hand-held device with a wireless communication function, a computing device, another processing devices connected to a wireless modem, a vehicle-mounted device, a wearable device, a station in a future 5G network, a station in a future evolved public land mobile network (Public Land Mobile Network, PLMN), or the like. This is not limited in this embodiment of this application.

The access point 101 in this embodiment of this application may be a device configured to communicate with the station. The access point may be an access point (Base Transceiver Station, BTS) in a global system for mobile communication (Global System for Mobile Communication, GSM) or code division multiple access (Code Division Multiple Access, CDMA). The access point may also be an access point (NodeB, NB) in a wideband code division multiple access (Wideband Code Division Multiple Access, WCDMA) system, may further be an evolved access point (Evolved NodeB, eNB or eNodeB) in an LTE system, or may further be a radio controller in a cloud radio access network (Cloud Radio Access Network, CRAN) scenario. Alternatively, the access point may be a relay station, an access point, a vehicle-mounted device, a wearable device, an access point in a future 5G network, an access point in the future evolved PLMN network, or the like. The station may also be referred to as a user terminal, a user apparatus, an access apparatus, a subscriber station, a subscriber unit, a mobile station, a user agent, user equipment, or the like. The user terminal may include various hand-held devices with a wireless communication function such as a vehicle-mounted device, a wearable device, a computing device, other processing devices connected to a wireless modem, user equipment (User Equipment, UE) in various forms, a mobile station (Mobile station, MS), a terminal (Terminal), a terminal equipment (Terminal Equipment), a portable communication device, a hand-held device, a portable computing device, an entertainment device, a game device or system. This is not limited in this embodiment of this application.

Optionally, a communication method in this application may also be applicable to communication between the access points 101, communication between the stations 102, or communication between the access point 101 and the station 102.

Optionally, the communication method in this application may be applied to various communication systems such as a GSM system, a CDMA system, a WCDMA system, a general packet radio service (General Packet Radio Service, GPRS), an LTE system, an LTE frequency division duplex (Frequency Division Duplex, FDD) system, an LTE time division duplex (Time Division Duplex, TDD) system, a universal mobile telecommunication system (Universal Mobile Telecommunication System, UMTS), a worldwide interoperability for microwave access (Worldwide Interoperability for Microwave Access, WiMAX) communication system, a future 5G system, a new radio (New Radio, NR) system, or the like.

In a conventional technology, a HARQ is generally classified into two types: chase combining (Chase Combining, CC) and incremental redundancy (Incremental Redundancy, IR).

If a HARQ type is CC, in a retransmission process, a transmit end retransmits coding bits that are the same as previously incorrectly transmitted coding bits, including information bits and check bits. A receive end combines the retransmitted coding bits with the previously received new coding bits. Herein, a log-likelihood ratio (Log-Likelihood ratio, LLR) corresponding to coding bits before decoding may be combined with an LLR corresponding to coding bits of currently received same information, and then the combined LLR values are decoded.

If the HARQ type is IR, in the retransmission process, a sender retransmits coding bits different from the previously transmitted coding bits, for example, retransmits additional check bits, or another part of the information bits and the check bits, or another part of coding codewords. The retransmitted bits may have different redundancy versions (Redundant Versions). The receive end combines original information and information of the additionally received retransmitted bits, and decodes them. Because there are fewer retransmitted bits, the HARQ IR has higher efficiency than the HARQ CC. However, because a coding codebook needs to be redesigned, complexity is higher.

To improve transmission efficiency of a media access control (Medium Access Control, MAC) frame, an aggregated media access control protocol data unit (Aggregated MAC Protocol Data Unit, A-MPDU) referred to as a media access control protocol data unit (MAC Protocol Data Unit, MPDU) is further introduced. The A-MPDU aggregates multiple MPDUs and sends them through one physical-layer preamble. This effectively reduces overheads caused by channel contention and the physical-layer preambles. FIG. 2 shows a frame format of the A-MPDU.

It should be understood that after undergoing a message integrity check (Messages Integrity Check, MIC), framing, and (optional) encryption, a media access control service data unit (MAC Service Data Unit, MSDU) added with a MAC header (control field) becomes a MAC protocol data unit (MAC Protocol Data Unit, MPDU). A physical layer service data unit (Presentation Service Data Unit, PSDU) carries the MPDU or the A-MPDU. The PSDU added with a preamble field may become a protocol data unit (Presentation Protocol Data Unit, PPDU). One PPDU may carry one or more PSDUs.

When a HARQ technology is used, a station stores an LLR corresponding to coding bits in an A-MPDU subframe including an MPDU that fails to be received last time, so that the station can perform combining and decoding or joint decoding on the LLR and an LLR of coding bits in an A-MPDU subframe including the same MPDU that is received this time. Two acknowledgment operations are introduced to determine whether information received by the receive end is correct.

A full state block acknowledgment (Full State Block Ack) operation: In the full state block acknowledgment, the receive end maintains a receive window in an acknowledgment state for each block acknowledgment session. A size of the receive window depends on a buffer size field carried in an interaction frame used in the block acknowledgment session set up for negotiation. The receive window is defined by a start sequence number WinStart, an end sequence number WinEnd, and a window length WinSize. The receive window is initialized when the block acknowledgment session is set up and its WinStart value is set to a start sequence number provided in an “ADDBA request frame”.

To reduce implementation difficulties of the receive end and support backward compatibility with a conventional full-state block acknowledgment policy, a new policy of partial state block acknowledgment is introduced in 802.11n and later standards.

A partial state block acknowledgment (Partial State Block Ack) operation: When receiving a quality of service (Quality of Service, QoS) data frame with a sequence number SN, the receive end checks whether there is a block acknowledgment receive window record of a related block acknowledgment session. The related block acknowledgment session is identified by a transmission address (TA) and a traffic type (Traffic Identification, TID). If the record does not exist, the receive end creates a receive window for the session. A WinEnd parameter of the receive window is equal to the SN, and a WinStart parameter is equal to (WinEnd−WinSize+1). Creating the receive window for the session and another block acknowledgment session may share a memory. If the data frame is correctly received, a record with a value of 1 is set at a location (WinEnd) indicating the SN.

The HARQ is not introduced in many communication systems. For example, because the HARQ requires a large cache be used to store data that needs to be combined, a HARQ mechanism is not introduced in a WLAN system using previous standards such as 802.11a/g/n/ac/ax.

This application provides a communication method in a wireless local area network. An LLR corresponding to coding bits in a buffer of the receive end can be discarded in time, to improve throughput of a system and reduce memory requirements.

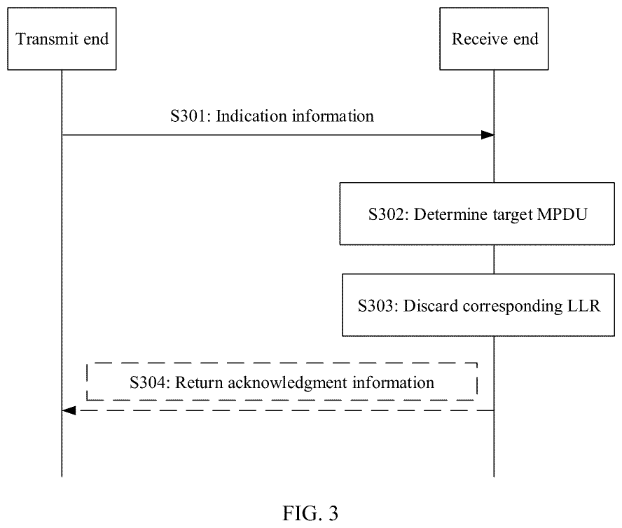

FIG. 3 is a schematic interaction diagram of the communication method in the wireless local area network. The communication method in FIG. 3 may be performed by the access point 101 and/or the station 102 in FIG. 1.

S301: A receive end receives indication information from a transmit end.

Optionally, the receive end may be the access point 101 or the station 102 in FIG. 1.

Optionally, the transmit end may be the access point 101 or the station 102 in FIG. 1.

Optionally, the indication information may be carried in a MAC frame. For example, the indication information may be a part of information in a data frame, a control frame, or a management frame.

Optionally, the indication information may be a part of information in a block acknowledgment request (block acknowledgment request, BAR) frame.

S302: The receive end may determine a target MPDU according to indication information received from the transmit end.

Optionally, a buffer of the receive end already stores an LLR corresponding to coded bits in an A-MPDU subframe including the target MPDU.

Optionally, after receiving the MPDU, the receive end may check whether the MPDU received by the receive end is correct according to a frame check sequence field carried in a decoded MPDU. If the check fails, the receive end stores a corresponding LLR in the buffer.

S303: The receive end discards the LLR corresponding to the coded bits in the A-MPDU subframe including the target MPDU according to the indication information.

Optionally, the method may further include S304: After receiving the indication information, the receive end may return acknowledgment information to the transmit end.

Optionally, the acknowledgment information may be a block acknowledgment (Block Acknowledgment, BA) frame or an acknowledgment (Ack) frame.

According to the method in this embodiment, the LLR corresponding to the coding bits in the buffer can be discarded in time, to improve throughput of a system and reduce memory requirements.

In a HARQ technology, the receive end needs to store the LLR for joint decoding, thereby improving the throughput of a system. However, storing the LLR corresponding to the coding bits increases the memory requirements. According to the communication method provided in this embodiment, an unnecessary LLR in the buffer can be discarded in time. This can reduce the memory requirements of the HARQ technology, and improve the throughput of a system.

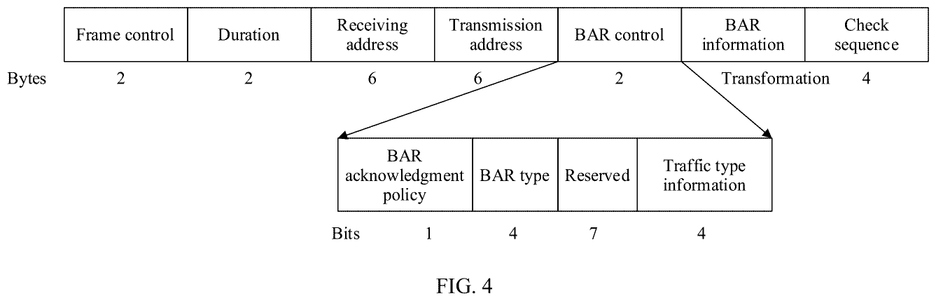

FIG. 4 is a schematic diagram depicting a format of a BAR frame.

The BAR frame may include a frame control (two bytes), a duration (two bytes), a receiving address (six bytes), a transmission address (six bytes), BAR control (two bytes), BAR information (changeable), and a frame check sequence (Frame Check Sequence, FCS) (four bytes).

The BAR control may include a BAR acknowledgment policy (one bit), a BAR type (four bits), reserved (seven bits), and traffic type information (TID-INFO) (four bits).

A BAR type in a BAR control field indicates a type of the BAR frame that may be used. Table 1 lists current existing BAR types.

TABLE 1

| BAR type value | BAR frame type |
|---|---|
| 0 | Basic (Basic) |
| 1 | Extended compressed (Extended Compressed) |
| 2 | Compressed (Compressed) |
| 3 | Multiple traffic types (Multi-TIDs) |
| 4-5 | Reserved |
| 6 | Multicast request (GCR group cast request) |
| 7-9 | Reserved |
| 10 | Common link-multicast request (GLK-GCR) |
| 11-15 | Reserved |

An embodiment of this application provides a method for discarding an LLR corresponding to coding bits in a buffer by using a BAR frame.

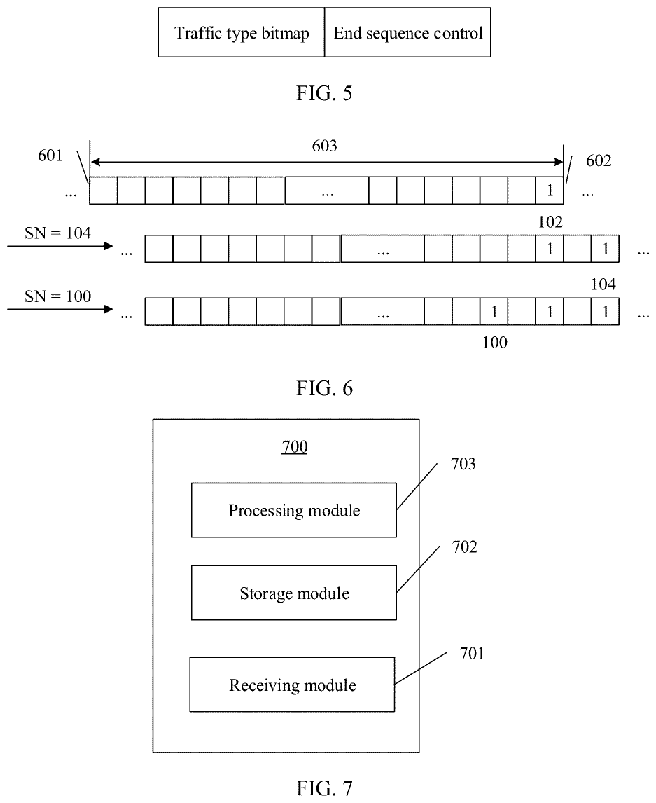

FIG. 5 is a schematic diagram of a BAR information field in a BAR frame.

Optionally, the indication information is the BAR information in the BAR frame.

Optionally, any one or more reserved values (for example, 11 to 15) of a BAR type in the BAR frame may be used to indicate that the BAR type is a HARQ BAR. Alternatively, a HARQ may be indicated by using reserved bits in a BAR control field. The HARQ indication may be used together with a BAR type. For example, if the BAR control field indicates that the BAR frame is the HARQ BAR, and the BAR type indicates that the BAR frame is basic, a type of the BAR frame is a basic HARQ BAR.

It should be understood that after receiving the BAR frame and identifying that the type of the BAR frame is the HARQ BAR, the receive end can discard the buffer according to the indication information.

Optionally, the BAR information may include an end sequence control (End Sequence Control).

The end sequence control may occupy two bytes, including an end sequence number (Sequence Number) and a fragment number (Fragment Number). The end sequence number is used to discard an LLR corresponding to coding bits whose sequence numbers are less than the end sequence number.

Optionally, the BAR information may include a traffic type bitmap (TID Bitmap).

Optionally, the traffic type bitmap may occupy two bytes, and is used to indicate one or more traffic types corresponding to the BAR frame, for example, to indicate that LLRs corresponding to coding bits in which traffic types in the buffer are discarded.

Optionally, a traffic type bitmap field is replaced with a traffic type field, and the traffic type field includes a 4-bit traffic type and a 12-bit reserved bit.

Optionally, the target MPDU is an MPDU, in MPDUs corresponding to the LLR stored in the buffer, whose sequence number is less than, or, less than or equal to the end sequence number.

Optionally, if the A-MPDU subframe uses sparsely arranged block code such as low density parity check (Low-density Parity-check, LDPC), the LLR corresponding to the coding bits in the A-MPDU subframe is an LLR corresponding to coding bits of coding codewords with a part or all of information bits included in the A-MPDU subframe. If only the part of the information bits of the coding codewords are included in the A-MPDU subframe, it indicates that the information bits of the codewords span two or more A-MPDU subframes. To be specific, another part of the information bits are included in one or more A-MPDU subframes before the A-MPDU subframe (referred to as a header), or included in one or more A-MPDU subframes after the A-MPDU subframe (referred to as a tail).

It should be understood that when the LLR corresponding to the coding bits in the A-MPDU subframe including the target MPDU is discarded from the buffer, coding bits corresponding to the information bits in the header and the information bits in the tail need to be discarded together.

Optionally, if the A-MPDU subframe carries binary convolution code (binary convolution code, BCC), the LLR corresponding to the coding bits is an LLR corresponding to coding bits output when the A-MPDU subframe is used as input of a BCC encoder.

Optionally, the target MPDU may be determined in the following several implementations according to the method provided in this embodiment of this application.

1a. The HARQ BAR type is used. The BAR information field may include an end sequence number control field. The target MPDU is the MPDU, in the MPDUs corresponding to the LLR stored in the buffer, whose sequence number is less than, or less than or equal to the end sequence number.

1b. The HARQ BAR type is used. The BAR information field may include a start sequence control field and the end sequence control field. The start sequence control field and the end sequence control field may be newly added fields in the BAR information, and sizes thereof may be 2 bytes. The target MPDU is the MPDU, in the MPDUs corresponding to the LLR stored in the buffer, whose sequence number is greater than, or greater than or equal to a sequence number in the start sequence control field and less than, or less than or equal to a sequence number in the end sequence control field.

1c. The HARQ BAR type is used. The BAR information field may include a sequence control field. The target MPDU is an MPDU, in the MPDUs corresponding to the LLR stored in the buffer, that is in an A-MPDU subframe including a specific MPDU.

2a. The HARQ BAR type is used. The BAR information field may include the traffic type bitmap field and the end sequence control field. The end sequence control field may be repeated based on a quantity of times that the traffic type bitmap is set to 1. Note that only the field is repeated, and the field may have different values. For example, the end sequence control field is repeated n times, where n is the quantity of times that the traffic type bitmap is set to 1. The target MPDU is the MPDU, in the MPDUs corresponding to the LLR stored in the buffer, whose sequence number is less than, or less than or equal to the end sequence number.

2b. The HARQ BAR type is used. The BAR information field may include the traffic type bitmap field, the start sequence control field, and the end sequence control field. The start sequence control field and the end sequence control field may be repeated based on the quantity of times that the traffic type bitmap is set to 1. Note that only the fields are repeated, and the fields may have different values. For example, the start sequence control field and the end sequence control field are repeated n times, where n is the quantity of times that the traffic type bitmap is set to 1. The target MPDU is the MPDU, in the MPDUs corresponding to the LLR stored in the buffer, whose sequence number is greater than, or greater than or equal to the sequence number in the start sequence control field and less than, or less than or equal to the sequence number in the end sequence control field.

3. For a multi-TID BAR frame, a similar method may also be used to indicate that a type of the multi-TID BAR frame is a HARQ multi-TID BAR frame. The foregoing method may be used to indicate multiple traffic. For example, the frame may include the traffic type bitmap field and the end sequence control field. The two fields may be repeated to indicate the multiple traffic. The target MPDU is the MPDU, in the MPDUs corresponding to the LLR stored in the buffer, whose sequence number is less than, or less than or equal to the end sequence number. Alternatively, the frame may include the traffic type bitmap field, the start sequence control field, and the end sequence control field. The target MPDU is the MPDU, in the MPDUs corresponding to the LLR stored in the buffer, whose sequence number is greater than, or greater than or equal to the sequence number in the start sequence control field and less than, or less than or equal to the sequence number in the end sequence control field.

4. For an MU-BAR frame, the similar method may also be used to indicate that a type of the MU-BAR frame is a HARQ MU-BAR. The foregoing method may be used to indicate the multiple traffic. A combination of other fields may also be used. For example, the frame may include an identity traffic type field and the end sequence control field. The identity traffic type field is used to determine to discard the LLRs corresponding to the coding bits in which traffic types in the buffer. The end sequence control field is used to determine to discard the LLR corresponding to the coding bits whose sequence numbers are less than, or less than or equal to the end sequence number. The two fields may be repeated. Alternatively, the frame may include the identity traffic type field, the start sequence control field, and the end sequence control field. The target MPDU is the MPDU, in the MPDUs corresponding to the LLR stored in the buffer, whose sequence number is greater than, or greater than or equal to the sequence number in the start sequence control field and less than, or less than or equal to the sequence number in the end sequence control field.

Optionally, the identity traffic type field includes an association identifier (Association Identifier, AID) and the TID. A frame including the AID and the TID is a trigger frame, but is not of the BAR type. It should be understood that the method in this embodiment of this application may be further applied to other existing BAR types, and is not limited to the several types provided in this application.

Optionally, after receiving a HARQ BAR frame of this type, the receive end may not return a BA response, and may return an Ack frame.

The any one or more reserved values in the BAR type are used to indicate that the BAR type is the HARQ BAR, and the BAR frame of this type is used to indicate the receive end to discard the LLR corresponding to the coding bits in the buffer. A TID bitmap in a BAR frame is provided. The end sequence number is used to discard an LLR corresponding to coding bits in a specific MPDU whose sequence number is less than the end sequence numbers. The receive end may discard, in time, an LLR of coding bits in an MPDU that is unnecessary, times out, or fails. Therefore, the receive end using a HARQ technology has lower requirements for a memory storing the LLR. In addition, according to this method, the receive end can efficiently discard the LLR in the buffer without a need to adjust a receive window.

An embodiment of this application provides a HARQ memory management mechanism. A HARQ LLR discarding mechanism is designed, so that the receive end may discard, in time, the LLR corresponding to the coding bits in an A-MPDU subframe of the MPDU that is unnecessary, times out, or fails. In this case, the receive end using the HARQ technology can reduce pressure to a memory caused by storing the LLR.

FIG. 6 is a schematic diagram of discarding an LLR corresponding to coding bits in a buffer by using moving of a receive window.

The receive window may be determined by a start sequence number WinStart601, an end sequence number WinEnd602, and a window length WinSize603.

Optionally, the indication information may be a sequence number of information received by the receive end.

In a first implementation, the receive end receives a data frame, and discards the LLR corresponding to the coding bits cached in the buffer based on a first sequence number carried in a received QoS data frame.

Optionally, after correctly receiving one MPDU in the QoS data frame, the receive end uses a sliding receive window to discard the LLR corresponding to the coding bits in the buffer.

Optionally, for each data frame related to a specific high-throughput immediate block acknowledgment (HT-immediate block ack) protocol, a receive end buffer record is modified as follows, where a first sequence number (SN1) is a sequence number value of a subfield in a received MPDU.

Optionally, the indication information may be SN1.

A. If WinStart601≤SN1≤WinEnd602, in Other Words, SN1 Falls within a Range of a Sequence Number Corresponding to the Receive Window

(1) If there is no MSDU with the same sequence number in the buffer of the receive end, the receive end stores the received MPDU in the buffer. Otherwise, the receive end discards the MPDU.

(2) If the sequence number SN1 of the received MSDU or A-MSDU is the same as that of WinStar601, the receive end sequentially transfers MSDUs or A-MSDUs in the buffer to an upper layer of an MAC layer in ascending order starting from SN1.

(3) Set WinStart601 to a value that is obtained by adding 1 to an SN of a last MSDU or A-MSDU transferred to the upper layer of the MAC layer.

(4) Set WinEnd602=WinStart601+WinSize63−1.

### B. If WinEnd602<SN1<WinStart602+2¹¹

2¹¹ is a half of a sequence space in which the receive window is located. (Currently, a sequence number is indicated by using 12 bits, and the sequence space is 2¹².) If the sequence space increases, the half of the sequence space may be modified accordingly.

(1) If there is no MSDU with the same sequence number, the receive end stores the received MPDU in the buffer. Otherwise, the receive end discards the MPDU.

(2) The receive window moves rightward in the sequence space, so that SN1 is located in the receive window. For example, the receive window is moved, so that WinEnd602=SN1.

(3) Based on WinEnd602 of an adjusted window, the receive end may determine WinStart601 of the receive window, and set WinStart601=WinEnd602−WinSize603+1.

Optionally, the target MPDU is an MPDU whose sequence number is less than a start sequence number of the adjusted receive window.

(4) The receive end transfers complete MSDUs or A-MSDUs stored in the buffer to the upper layer of the MAC layer.

Optionally, the receive end transfers an MSDU or A-MSDU whose sequence number is less than an adjusted WinStart601 in the buffer to the upper layer of the MAC layer in ascending order.

Sequence numbers of MSDUs or A-MSDUs transferred to the upper layer of the MAC layer may be discontinuous.

Optionally, LLRs that correspond to coding bits in an A-MPDU subframe including an MPDU with a related sequence number and that are discarded are specifically LLRs corresponding to coding bits in an A-MPDU subframe including an MPDU encapsulated in an MSDU or an A-MSDU. The LLRs include LLRs (only for block code, for example, LDPC) of the coding bits corresponding to the information bits in the header and the tail. SN values of the MSDUs or A-MSDUs are less than a value of a new WinStart.

(5) For a non-bidirectional multi-gigabit ethernet bit (directional multi-gigabit, DMG) STA, the receive end sequentially transfers the MSDUs or A-MSDUs stored in the buffer to the upper layer of the MAC layer in ascending order of sequence numbers starting from WinStart601, until there is no MSDU or A-MSDU with a next sequence number value in the buffer.

(6) Set WinStart601 to the value that is obtained by adding 1 to the sequence number of the last MSDU or A-MSDU transferred to the upper layer of the MAC layer.

(7) Set WinEnd602=WinStart601+WinSize603−1.

### C. If WinStart601+2¹¹≤SN1<WinStart601

2¹¹ is a half of a sequence space in which the receive window is located. (Currently, a sequence number is indicated by using 12 bits, and the sequence space is 2¹².) If the sequence space increases, the half of the sequence space may be modified accordingly.

Optionally, the MPDU is discarded, and the LLR corresponding to the coding bits in the A-MPDU subframe including the MPDU is not stored.

According to this communication method, the receive end may discard, in time, the LLR corresponding to the coding bits in the A-MPDU subframe of the MPDU that is unnecessary, times out, or fails. In this case, the receive end using a HARQ technology can reduce pressure to a memory caused by storing the LLR. In addition, the transmit end device does not need to additionally send another indication indicating the receive end to discard the LLR in the buffer. Therefore, the transmit end can improve its efficiency and the LLR corresponding to the unnecessary coding bits is discarded in time.

In a second implementation, the receive end receives the BAR frame, and discards the LLR corresponding to the coding bits stored in the buffer based on a second sequence number carried in the BAR frame.

For each BAR frame related to the specific HT-immediate block ack protocol, the buffer of the receive end is modified according to the following condition, and the second sequence number (SN2) is indicated by using a start sequence number subfield in the BAR frame:

Optionally, the indication information may be SN2. The SN2 may be a value of a start sequence number (Start Sequence Number, SSN) subfield of a received BAR frame. Optionally, the SSN may be set according to different requirements.

### A. If WinStart601<SN2<WinStart601+2¹¹

2¹¹ is a half of a sequence space in which the receive window is located (currently, a sequence number is indicated by using 12 bits, and the sequence space is 2¹²). If the sequence space increases, the half of the sequence space may be modified accordingly.

(1) In a block acknowledgment protocol that is not protected, the receive end adjusts the receive window, so that the second sequence number falls within a sequence number value range corresponding to the receive window. The receive window is moved, so that WinStart 601=SN2.

(2) Based on WinStart601 of the adjusted window, the receive end may determine WinEnd602 of the receive window, and set WinEnd602=WinStart601+WinSize 603−1.

(3) The receive end transfers complete MSDUs or A-MSDUs stored in the buffer to the upper layer of the MAC layer.

Optionally, the receive end transfers MSDUs or A-MSDUs whose SNs in the buffer are less than a new WinStart601 to the upper layer of the MAC layer in ascending order.

Sequence numbers of the MSDUs or the A-MSDUs transferred to the upper layer of the MAC layer may be discontinuous.

Optionally, LLRs that correspond to the coding bits in the A-MPDU subframe including the MPDU with the related sequence number and that are discarded are specifically LLRs corresponding to the coding bits in the A-MPDU subframe including an MPDU encapsulated in an MSDU or an A-MSDU. The LLRs include LLRs (only for the block code, for example, the LDPC) of the coding bits corresponding to the information bits in the header and the tail. Sequence numbers of the MSDUs or A-MSDUs are less than a value of the adjusted WinStart.

(4) The receive end sequentially transfers the MSDUs or A-MSDUs in the buffer to the upper layer of the MAC layer in ascending order of sequence numbers starting from WinStart601, until there is no MSDU or A-MSDU with a next sequence number value in the buffer.

(5) Set WinStart601 to a value that is obtained by adding 1 to a value of a sequence number of a last MSDU or A-MSDU transferred to the upper layer of the MAC layer.

(6) The receive end may determine WinEnd602 based on WinStart601, and set WinEnd602=WinStart601+WinSize603−1.

### B. If WinStart601+2¹¹≤SN2<WinStart601

2¹¹ is a half of a sequence space in which the receive window is located. (Currently, a sequence number is indicated by using 12 bits, and the sequence space is 2¹².) If the sequence space increases, the half of the sequence space may be modified accordingly.

Optionally, no change may be made to a receive buffer.

According to this communication method, the receive end may discard, in time, the LLR corresponding to the coding bits in the A-MPDU subframe including the MPDU that is unnecessary, times out, or fails. In this case, the receive end using a HARQ technology can reduce memory pressure to a memory caused by storing the LLR.

In addition, the transmit end device may help the receive end discard the LLR corresponding to the coding bits by using the second sequence number in the existing BAR frame in a buffer space.

An embodiment of this application provides a method for discarding an LLR corresponding to coding bits in a buffer by using a preamble of a PPDU.

Optionally, the indication information may be retransmission indication information in the preamble.

The LLR in the MPDU is discarded according to the retransmission indication information in the preamble. A HARQ procedure is not described in this application. For emphasis, it is assumed that there is only one HARQ procedure.

Optionally, if the retransmission information is a first value, for example, 0, it indicates that the PPDU carries a retransmitted MPDU that does not require a HARQ operation or does not carry a retransmitted MPDU.

Optionally, the target MPDU may be LLRs of all coding bits stored in the buffer, that is, LLRs corresponding to coding bits in A-MPDU subframes including all previously stored MPDUs.

Optionally, if the retransmission information is a second value, for example, 1, it indicates that the PPDU carries the retransmitted MPDU, and combining and decoding or joint decoding are or is performed on the retransmitted MPDU and the LLR corresponding to the coding bits.

It should be understood that it is assumed that there is only one HARQ procedure in this embodiment of this application. There may be multiple HARQ procedures during actual application.

It is assumed that the receive end supports N HARQ procedures.

If the retransmission information is the first value, for example, 0, it indicates that the PPDU carries the retransmitted MPDU that does not require a HARQ operation or does not carry the retransmitted MPDU. The receive end continues to retain LLEs corresponding to stored coding bits of an A-MPDU subframe including a failed MPDU in latest N−1 transmissions, and discards LLRs corresponding to other stored coding bits.

Optionally, if the retransmission information is the second value, for example, 1, it is indicated that the PPDU carries the retransmitted MPDU, and combining and decoding or joint decoding are or is performed on the retransmitted MPDU and the LLR corresponding to the coding bits in one of the N HARQ procedures at the receive end.

According to this communication method, the receive end may discard, in time, the LLR corresponding to the coding bits in the A-MPDU subframe including the MPDU that is unnecessary, times out, or fails. In this case, the receive end using a HARQ technology can reduce memory pressure to a memory caused by storing the LLR.

In addition, the transmit end device does not need to additionally send another indication indicating the receive end to discard the LLR in the buffer. Therefore, the transmit end can improve its efficiency and the LLR corresponding to the unnecessary coding bits is discarded in time.

FIG. 7 is a schematic diagram of a communication apparatus 700 according to an embodiment of this application. The apparatus 700 may be a receive end, or may be a chip in the receive end.

The communication apparatus 700 may be a specific example of the access point 101 or the station 102 in FIG. 1.

As shown in FIG. 7, the communication apparatus 700 may include a receiving module 701 and a processing module 703, and may optionally further include a storage module 702.

The receiving module 701 is configured to receive indication information. The receiving module 701 may be a communication interface in the communication apparatus 700, for example, an input/output interface, configured to receive the indication information, and transfer the indication information to the storage module. The indication information may be transmitted to the communication interface by another communication apparatus, or may be first received by an antenna of the communication apparatus and then transmitted to the communication interface. The storage module 702 includes a buffer. The buffer stores a log-likelihood ratio (LLR) corresponding to coded bits in an aggregated media access control protocol data unit (A-MPDU) subframe including a target media access control protocol data unit (MPDU). The processing module is configured to discard the LLR corresponding to the coded bits in the A-MPDU subframe including the target MPDU according to the indication information.

Optionally, the processing module may be configured to indicate the storage module 702 to discard or delete the LLR corresponding to the coded bits in the A-MPDU subframe including the target MPDU according to the indication information received by the receiving module 701.

Optionally, the indication information may be BAR information in a BAR frame. The BAR frame further includes BAR type information. The BAR type information may be used to indicate that the BAR frame corresponds to a hybrid automatic repeat request (HARQ).

Optionally, the BAR information includes an end sequence number. The target MPDU is an MPDU whose sequence number in an MPDU corresponding to an LLR stored in the buffer is less than the end sequence number.

Optionally, the BAR frame further includes a traffic type bitmap. The traffic type bitmap is used to indicate traffic corresponding to the BAR frame.

Optionally, the indication information is a first sequence number of an MPDU carried in a received MAC frame. If the first sequence number is greater than an end sequence number of a receive window of the receive end and is less than a start sequence number+2¹¹, the processing module is further configured to adjust the receive window, so that the first sequence number is located in the receive window. The processing module is further configured to determine an MPDU whose sequence number is less than a start sequence number of an adjusted receive window as the target MPDU.

Optionally, an adjusted end sequence number is the first sequence number, and an adjusted start sequence number is equal to the end sequence number−a window length+1.

Optionally, if the first sequence number is less than the start sequence number of the receive window of the receive end and is greater than or equal to the start sequence number+2¹¹, the communication apparatus does not buffer an LLR corresponding to coding bits in a received A-MPDU subframe including an MPDU.

Optionally, the indication information is a second sequence number indicated by a start sequence number subfield in the BAR frame. If a second sequence number is greater than the start sequence number of the receive window of the receive end and is less than the start sequence number+2¹¹, the processing module is further configured to adjust the receive window, so that the start sequence number is equal to the second sequence number. The processing module is further configured to determine the MPDU whose sequence number is less than the start sequence number of the adjusted receive window as the target MPDU.

Optionally, the indication information is retransmission indication information in a preamble of a physical layer protocol data unit (PPDU). If the retransmission indication information is a first value, the PPDU does not carry a retransmitted MPDU or carries a retransmitted MPDU that does not require a HARQ operation, and the target MPDU is all of the MPDUs corresponding to the LLR stored in the buffer. If the retransmission indication information is a second value, the PPDU carries a retransmitted MPDU, and combining and decoding or joint decoding are or is performed on the retransmitted MPDU and the LLR corresponding to the coding bits.

Optionally, the processing module 703 may be a processor, and the storage module 702 may be a cache included in the processor or an independent storage medium coupled to the processor.

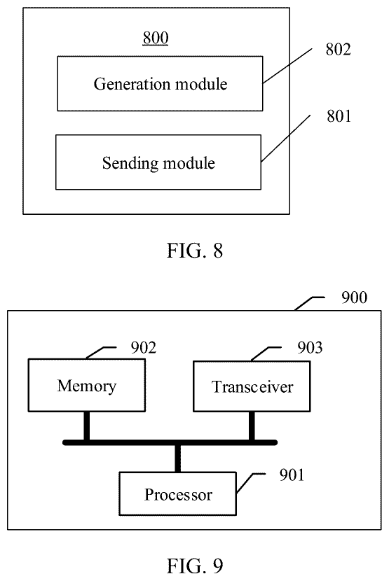

FIG. 8 is a schematic diagram of a communication apparatus 800 according to an embodiment of this application.

The communication apparatus 800 may be a specific example of the access point 101 or the station 102 in FIG. 1, or may be a chip in the access point or the station.

As shown in FIG. 8, the communication apparatus 800 may include a sending module 801.

The sending module 801 is configured to send indication information to a receive end. The indication information is used to indicate the receive end to discard an LLR corresponding to coded bits in an A-MPDU subframe including a target MPDU according to the indication information.

The communication apparatus 800 may further include a generation module 802, configured to generate the indication information.

Optionally, the indication information is BAR information in a block acknowledgment request (BAR) frame. The BAR frame further includes BAR type information. The BAR type information is used to indicate that the BAR frame corresponds to a hybrid automatic repeat request (HARQ).

Optionally, the BAR information includes an end sequence number. The target MPDU is an MPDU whose sequence number in an MPDU corresponding to an LLR stored in a buffer is less than the end sequence number.

Optionally, the BAR frame further includes a traffic type bitmap. The traffic type bitmap is used to indicate traffic corresponding to the BAR frame.

Optionally, the indication information is retransmission indication information in a preamble of a physical layer protocol data unit (PPDU). If the retransmission indication information is a first value, the PPDU does not carry a retransmitted MPDU or carries a retransmitted MPDU that does not require a HARQ operation, and the target MPDU is all of the MPDUs corresponding to the LLR stored in the buffer. If the retransmission indication information is a second value, the PPDU carries a retransmitted MPDU, and combining and decoding or joint decoding are or is performed on the retransmitted MPDU and the LLR corresponding to the coding bits.

FIG. 9 is a schematic diagram depicting a structure of a communication apparatus 900 according to an embodiment of this application. The communication apparatus 900 may be the access point or the station in the foregoing embodiments, and is configured to implement operations of the station or the access point in the foregoing embodiments. As shown in FIG. 9, the communication apparatus includes a processor 901, a memory 902, and a transceiver 903.

The processor 901 may include a host CPU and other integrated circuits. The memory 902 may be configured to store data and a program. A program configured to perform the method performed by the access point or the station in the foregoing methods may be stored in the storage element 902. The transceiver 903 is configured to communicate with other stations, access points, or interfaces in an electronic device. The station or access point may be implemented by using a chip. The chip includes at least one processor and a transceiver. The processor is configured to implement steps of any method performed by the foregoing communication apparatus. The processor may include a memory configured to store data and a program. The transceiver is configured to communicate with other apparatuses. In an implementation, units of the communication apparatus 900 for implementing the steps in the foregoing method may be implemented by the programed invoked by the processor. For example, the apparatus used as the station includes the processor and the memory, and the processor invokes the program stored in the memory to perform the method performed by a terminal in the foregoing method embodiments. The memory and the processor may be located on a same chip. In other words, the memory may be an on-chip memory.

An embodiment of this application further provides an apparatus. The apparatus includes a communication interface, a processor, and a memory. The communication interface is configured to receive indication information. The memory is configured to store a log-likelihood ratio (LLR) corresponding to coded bits in an aggregated media access control protocol data unit (A-MPDU) subframe including a target media access control protocol data unit (MPDU). The processor is configured to invoke, according to the indication information, the memory to discard the LLR that is stored in the memory and that corresponds to the coded bits in the A-MPDU subframe including the target MPDU. Optionally, the memory may be an internal memory inside the processor, or may be an external memory coupled to the processor.

An embodiment of this application further provides another chip. The chip may be an internal chip of a receive end or a transmit end. The chip includes a processor and a communication interface. The communication interface and a processing circuit are connected through an internal connection path. The communication interface is configured to receive indication information. The processing circuit is configured to discard an LLR corresponding to coded bits in an A-MPDU subframe including a target MPDU according to the indication information.

An embodiment of this application provides a chip. The chip includes a processor. The processor and a memory are connected through an internal connection path. The processor is configured to execute code in the memory. When the code is executed, the processor is enabled to perform the method in any one of the foregoing embodiments.

An embodiment of this application further provides an apparatus, configured to implement the method in any one of the foregoing embodiments.

A person of ordinary skill in the art may be aware that, in combination with the examples described in the embodiments disclosed in this specification, units and algorithm steps can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected depending on actual requirements to achieve the objectives of the solutions in the embodiments.

In addition, function units in the embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer program instructions are loaded and executed on a computer, all or some of the procedures or the functions according to the embodiments of the present invention are generated. The computer may be a general-purpose computer, a special-purpose computer, a computer network, or another programmable apparatus. The computer instructions may be stored in a computer-readable storage medium or may be transmitted from a computer-readable storage medium to another computer-readable storage medium. For example, the computer instructions may be transmitted from a web station, computer, server, or data center to another web station, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive Solid-State Drive (SSD)), or the like.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication method, comprising:
receiving, by a receive end, indication information from a transmit end; and
discarding, by the receive end, a log-likelihood ratio (LLR) corresponding to coded bits in an aggregated media access control protocol data unit (A-MPDU) subframe including a target media access control protocol data unit (MPDU) according to the indication information.

2. The method according to claim 1, wherein the indication information comprises block acknowledgment request (BAR) information in a BAR frame, and the BAR frame further comprises BAR type information indicating that the BAR frame corresponds to a hybrid automatic repeat request (HARQ).

3. The method according to claim 2, wherein the BAR information comprises an end sequence number, and the target MPDU comprises an MPDU whose sequence number in the MPDU corresponding to the LLR stored in a buffer is less than the end sequence number.

4. The method according to claim 2, wherein the BAR frame further comprises a traffic type bitmap, and the traffic type bitmap is used to indicate traffic corresponding to the BAR frame.

5. The method according to claim 1, wherein:
the indication information comprises a first sequence number of an MPDU carried in a received medium access control (MAC) frame;
when the first sequence number is greater than an end sequence number of a receive window of the receive end and is less than a start sequence number+2¹¹, adjusting, by the receive end, the receive window, wherein the first sequence number is located in the receive window; and
the target MPDU comprises an MPDU whose sequence number is less than a start sequence number of the adjusted receive window.

6. The method according to claim 5, wherein an adjusted end sequence number is the first sequence number, and an adjusted start sequence number is equal to the end sequence number−a window length+1.

7. The method according to claim 5, the method further comprises:
when the first sequence number is less than the start sequence number of the receive window of the receive end and is greater than or equal to the start sequence number+2¹¹, refraining from buffering, by the receive end, an LLR corresponding to coding bits in a received A-MPDU subframe including an MPDU.

8. The method according to claim 1, wherein:
the indication information comprises a second sequence number indicated by a start sequence number subfield in a BAR frame;
when a second sequence number is greater than the start sequence number of a receive window of the receive end and is less than the start sequence number+2¹¹, adjusting, by the receive end, the receive window, wherein the start sequence number is equal to the second sequence number; and
determining, by the receive end, an MPDU whose sequence number is less than a start sequence number of the adjusted receive window as the target MPDU.

9. The method according to claim 1, wherein:
the indication information comprises retransmission indication information in a preamble of a physical layer protocol data unit (PPDU);
when the retransmission indication information is a first value, the PPDU does not carry a retransmitted MPDU or carries a retransmitted MPDU that does not require a HARQ operation, and the target MPDU comprises all of MPDUs corresponding to the LLR stored in a buffer; and
when the retransmission indication information is a second value, the PPDU carries a retransmitted MPDU, and at least one of combining and decoding or joint decoding is performed on the retransmitted MPDU and the LLR corresponding to coding bits.

10. A communication method, comprising:
sending, by a transmit end, indication information to a receive end, wherein the indication information is used to indicate the receive end to discard a log-likelihood ratio (LLR) corresponding to coded bits in an aggregated media access control protocol data unit (A-MPDU) subframe including a target media access control protocol data unit (MPDU) according to the indication information.

11. The method according to claim 10, wherein the indication information comprises block acknowledgment request (BAR) information in a BAR frame, and the BAR frame further comprises BAR type information indicating that the BAR frame corresponds to a hybrid automatic repeat request (HARQ).

12. The method according to claim 11, wherein the BAR information comprises an end sequence number, and the target MPDU comprises an MPDU whose sequence number in an MPDU corresponding to an LLR stored in a buffer is less than the end sequence number.

13. The method according to claim 11, wherein the BAR frame further comprises a traffic type bitmap, and the traffic type bitmap is used to indicate traffic corresponding to the BAR frame.

14. The method according to claim 12, wherein:
the indication information comprises retransmission indication information in a preamble of a physical layer protocol data unit (PPDU);
when the retransmission indication information is a first value, the PPDU does not carry a retransmitted MPDU or carries a retransmitted MPDU that does not require a HARQ operation, the target MPDU comprises all of the MPDUs corresponding to the LLR stored in the buffer; and
when the retransmission indication information is a second value, the PPDU carries a retransmitted MPDU, and at least one of combining and decoding or joint decoding is performed on the retransmitted MPDU and the LLR corresponding to coding bits.

15. A communication apparatus, comprising:
one or more processors; and
a memory storing a program to be executed by the one or more processors, wherein the program comprises instructions that when executed by the one or more processors, cause the communication apparatus to perform operations comprising:
receiving indication information from a transmit end; and
discarding a log-likelihood ratio (LLR) corresponding to coded bits in an aggregated media access control protocol data unit (A-MPDU) subframe including a target media access control protocol data unit (MPDU) according to the indication information.

16. The apparatus according to claim 15, wherein the indication information comprises block acknowledgment request (BAR) information in a BAR frame; and the BAR frame further comprises BAR type information indicating that the BAR frame corresponds to a hybrid automatic repeat request (HARQ).

17. The apparatus according to claim 16, wherein the BAR information comprises an end sequence number, and the target MPDU comprises an MPDU whose sequence number in the MPDU corresponding to the LLR stored in a buffer is less than the end sequence number.

18. The apparatus according to claim 16, wherein the BAR frame further comprises a traffic type bitmap, and the traffic type bitmap is used to indicate traffic corresponding to the BAR frame.

19. The apparatus according to claim 15, wherein:
the indication information comprises a first sequence number of an MPDU carried in a received medium access control (MAC) frame;
when the first sequence number is greater than an end sequence number of a receive window of a receive end and is less than a start sequence number+2¹¹, adjusting, by the receive end, the receive window, wherein the first sequence number is located in the receive window; and
the target MPDU comprises an MPDU whose sequence number is less than a start sequence number of the adjusted receive window.

20. The apparatus according to claim 19, wherein an adjusted end sequence number is the first sequence number, and an adjusted start sequence number is equal to the end sequence number−a window length+1.
